(19) United States
(12) Patent Application Publication
(10) Pub. No.: US 2009/0102846 A1
(43) Pub. Date: Apr. 23, 2009

(54) Rendering Graphics Using Fonts

(76) Inventors: Andreas Flockermann, Garmstadt (DE); Andreas Lipphardt, Garmstadt (DE)

Correspondence Address: SoCAL IP LAW GROUP LLP, 310 N. WESTLAKE BLVD. STE 120, WESTLAKE VILLAGE, CA, 91362, US

(21) Appl. No.: 11/874,706

(22) Filed: Oct. 18, 2007

(51) Int. Cl. G06T 11/20; G06F 15/00; G06T 1/60

(52) U.S. Cl. 345/440; 345/156; 345/501; 345/530

(57) ABSTRACT

Methods for rendering graphics using a proprietary font are disclosed. A method includes receiving data, receiving graph parameters, preparing graphics rendering instructions based on the received data, the received chart parameters, and at least one proprietary font. The graphics rendering instructions comprise a character string and color parameters. The method may include rendering a graph based on the graphics rendering instructions by accessing a proprietary font. The method may be performed by a computing device alone or in a client-server configuration.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to inline generation of graphs and charts in files and documents displayed on computing devices using fonts.

2. Description of the Related Art

Data of all kinds is reported and displayed everywhere, from newspapers and magazines to technical journals and on television, Data may reflect the state of the economy, the value of a stock, the values of a group of stocks, sports scores, commodities pricing, home values, school grades, temperatures, fuel economy, infection rates and many other things. Nonetheless, most data is presented as a single, isolated value: a big company's turnover, the current unemployment rate or the last reading of a stock quote. But data is often presented out of context. And data taken out of context is often misleading. However, the necessary context can be provided easily, with the help of graphs and charts. Graphs and charts allow the human eye to readily make comparisons and detect patterns, allowing a person to gain immediate insight into the story told by the data.

### DESCRIPTION OF THE DRAWINGS

The file of this patent contains at least one drawing executed in color. Copies of this patent or patent application publication with color drawings will be provided by the Patent and Trademark Office upon request and payment of the necessary fee.

FIG. 1 is a block diagram of an environment in which a graphics rendering method may be implemented.

FIG. 2 is an illustration of two flow charts showing the steps taken to achieve a graphics rendering method.

FIG. 3 is a table and illustrations representing a method of rendering graphics.

FIG. 4 is a table and illustrations representing an improved method of rendering graphics.

FIG. 5 is an illustration of the constituent components of a pie chart according to a method of rendering graphics.

FIG. 6 is an illustration of a method of rendering a line graph according to a method of rendering graphics.

FIG. 7 is a series of three illustrations showing how graphs are rendered according to an improved method of rendering graphics.

FIG. 8 is a block diagram of a detailed view of example glyphs of a font used to render bar charts.

FIG. 9 is a block diagram of a detailed view of example glyphs of a font used to render line charts.

FIG. 10 is a block diagram of a detailed view of example glyphs of a font used to render pie charts.

FIG. 11 is a block diagram of a detailed view of example glyphs of a font used to render horizontal bar charts and bullet graphs.

FIG. 12 is an example insert function dialog box used to insert a graphic according to an embodiment of a method of rendering graphics.

FIG. 13 illustrates three example chart selection dialog boxes according to an embodiment of a method of rendering graphics.

FIG. 14 illustrates four example chart selection dialog boxes according to an embodiment of a method of rendering graphics.

FIG. 15 is an example function arguments dialog box according to an embodiment of a method of rendering graphics.

FIG. 16 is an example source data and chart location dialog box according to an embodiment of a method of rendering graphics.

FIG. 17 illustrates four example chart format dialog boxes according to an embodiment of a method of rendering graphics.

FIG. 18 is a screen shot of an example spread sheet including bar graphs rendered according to a method described herein.

FIG. 19 is a screen shot of an example spread sheet including pie charts rendered according to a method described herein.

FIG. 20 is a screen shot of a portion of an example spread sheet including various charts and graphs rendered according to a method described herein.

FIG. 21 is screen shot of a portion of an example spread sheet showing the data used to create the charts and graphs shown in FIG. 20.

FIG. 22 is a screen shot of a portion of an example spread sheet including graphs having an axis and a legend rendered according to a method described herein.

### DETAILED DESCRIPTION

An Environment

The methods described herein allow application programs, widgets and other software to render multicolored graphics and carefully crafted graphics using font techniques so that data may be more readily comprehended, thus improving the communication of the data. In one embodiment, this is achieved using a group of proprietary TrueType fonts.

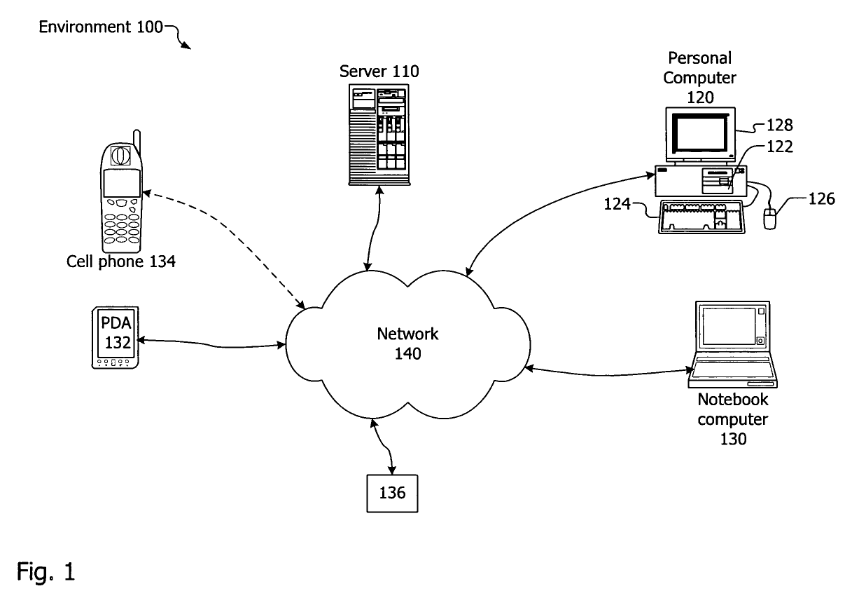

The graphics rendering methods may be implemented in an environment 100 shown in FIG. 1. The client devices 120, 130, 132 and 136 include software and data for providing the functionality and features of the graphics rendering system described herein. The server 110 may also include software and/or data for providing the functionality and features described herein. The server 110 may provide data to the client devices which may be rendered as graphics using software running on the client devices. The server 110 may format graphics and prepare graphics rendering instruction in the form of character strings that invoke a proprietary font for display on a client device.

Client devices 120, 130, 132 and 136 and server 110 may be computing devices. A computing device as used herein refers to a device with a processor, memory, and a storage device and/or storage medium. A computing device may also have a network interface included therein. As used herein, a network interface is a computer chip, chipset, circuit board, or add-in board that allows a computing device to communicate over a wireless or wired network. The term computing device includes, but is not limited to, personal computers 120, server computers 110, computing tablets, set top boxes, video game systems, personal video recorders, telephones, cellular telephones 134, digital telephones, personal digital assistants (PDAs) 132, portable computers, notebook computers 130, laptop computers, and personal media players including audio players such as an Apple iPod and multimedia players such as Microsoft Zune. These computing devices may run an operating system, including, for example, variations of the Linux, Unix, MS-DOS, Microsoft Windows, Palm OS, Symbian, and Apple Mac OS X operating systems.

The techniques described herein may be implemented in software stored on storage media accessible either directly or via a storage device included with or otherwise coupled with or attached to a computing device such as personal computer 120, notebook computer 130, cellular telephone 134, PDA or other computing device 136. The storage media include, for example, magnetic media such as hard disks, floppy disks and tape; optical media such as compact disks (CD-ROM and CD-RW), digital versatile disks (DVD and DVD±RW), and high definition (HD) DVD and Blu-Ray disks; flash memory cards; and other storage media. As used herein, a storage device is a device that allows for reading and/or writing to a storage medium. Storage devices include, hard disk drives 122, optical disc players and recorders (CD-ROM, DVD, Blu-Ray drives, combo players), flash memory devices (such as readers and writers), and others.

The functionality and features of the graphics rendering system may be embodied in whole or in part in software which operates on a computing device, and may be in the form of, for example, one or more of an application program, an applet (e.g., a Java applet), an application program plug-in, a browser plug-in, AJAX software, a COM object, a dynamic linked library (DLL), a script, one or more subroutines, an operating system component or service and may be programmed in a high level language such as, for example, C, C++, and Java, or a low level language such as an assembler language.

Computing devices such as the client devices typically include a display, user input devices, and a storage media and storage device. For example, when the computing device is a personal computer 120, the personal computer 120 includes a display 128, a keyboard 124, a mouse 126 and a hard disk drive 122. When the computing device is a cellular telephone 134, the cellular telephone 134 includes a display, a keypad, and various control keys and/or buttons, and may include a keyboard in hardware and/or software. Other and multiple user input devices may be included in or with the computing devices. Computing devices may have multiple displays, multiple network interfaces and/or multiple storage devices. Other devices may also be coupled with or included in the computing devices.

Server 110 is also a computing device and refers to a device with a processor, memory, a network interface and a storage device. A server is typically more robust than a client device and typically has greater processing capabilities, greater network throughput, larger memory, and/or greater storage space when compared to a personal computer or other client device. Although shown as a single server, server 110 may be a server farm, group of servers (including application servers, database servers, content servers, and others), and may include a firewall, load balancer, router, and other network devices; and may include multiple devices in multiple locations that communicate over private or public communication media. The server 110 may provide facilities to receive and process data to create instructions for rendering graphics based on the received data, and may serve graphics rendering instructions to client devices. The server 110 may receive data from one or more clients and/or one or more servers.

In the environment 100, client devices 120, 130, 132 and 136 may communicate over network 140 with other client devices and with one or more servers 110. In one embodiment, network 140 is the Internet. Network 140 may support various versions of the Ethernet protocol and other communications protocols including packet switched and/or circuit switched protocols. The client devices and server 110 may communicate over the network 140 via wired and/or wireless communications. The communications may be encrypted or otherwise made secure. The client devices and server 110 communicate data units over the network 140. As used herein, a data unit refers to a frame, cell, datagram, packet or other unit of information.

The Overall Processes

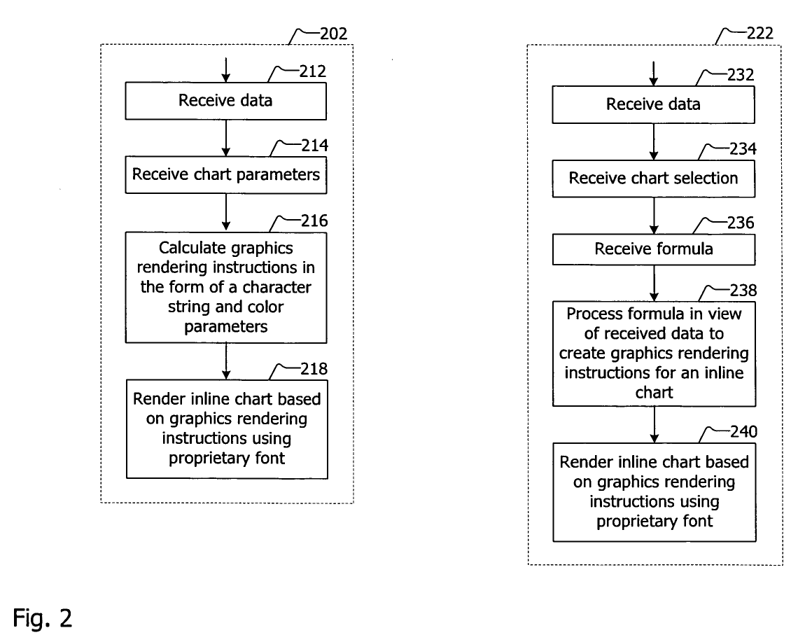

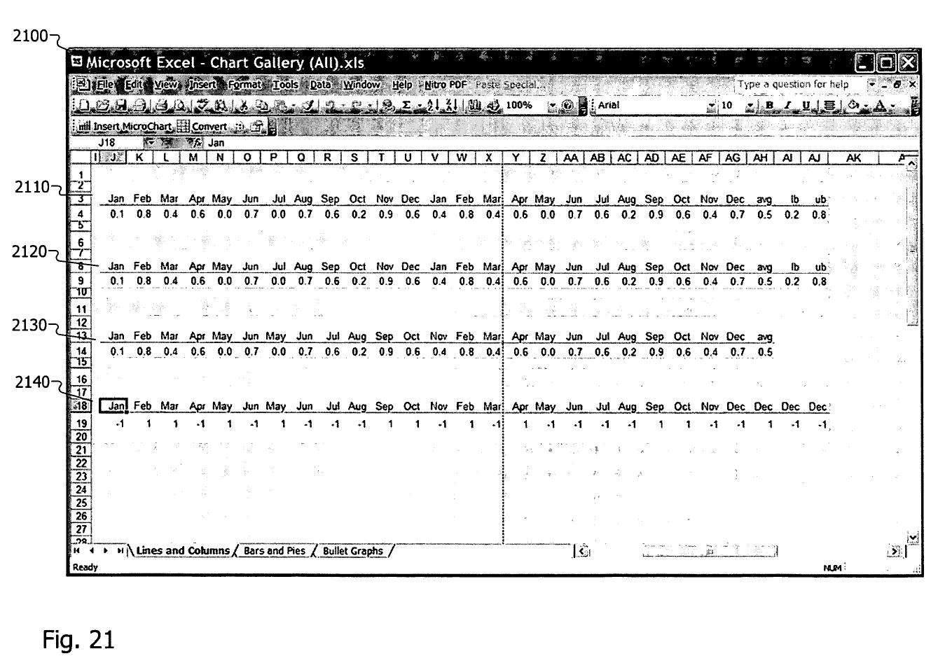

The basic process of rendering graphics is described in flow chart 202 of FIG. 2. In this flow chart, data is received, as shown in block 212. The data may be in the form of a spreadsheet such as that shown in FIG. 21. The data may be stored in or accessible from a local or remote database. Chart parameters are then received, as shown in block 214. In general, chart parameters include a user or computer program specification of: the type of chart or graph to be rendered, such as, for example, line, bar, pie, bullet, win-lose or other charts or graphs; whether a reference line is used; whether chart elements should have a particular color; and others. Chart parameters may include data processing and data evaluation instructions and/or formulas. The chart parameters may be specified according to a published application programming interface (API) and received by a graphics engine that conforms to or otherwise supports the API. The API may provide different interfaces for each type of chart or graph desired. For example, different function calls may be provided that allow for the preparation of graphics rendering instructions for color or black and white line charts, bar graphs, a bullet graphs, area graphs, and others.

In one embodiment, the line chart parameters for a “create line chart” function include:

| Values | source data of the chart |
|---|---|
| SeriesInRows | specifies whether the series of source data |
| | are in rows or in columns |
| ColorLine | color for the chart line |
| ColorPoint | color the chart points |
| ColorPeriod | color palette used for the period format |
| PeriodLength | period length used for the period format |
| LineType | line type of the chart |
| ScaleFactor | scale factor of the chart width |
| ColorOpen | color used for the open value |
| ColorClose | color used for the close value |
| ColorLow | color used for the low value |
| ColorHigh | color used for the high value |
| ColorNmlBnd | color used for the normal band |
| LowerBound | lower bound value of the normal band |
| UpperBound | upper bound value of the normal band |
| ReferenceValueColor | index of the current color palette used |
| | for the reference line |
| ReferenceValue | reference value used for the reference line |
| Min | number at which the y-axis starts |
| Max | number at which the y-axis ends |
| ColorArea | color used for the chart area |

Graphics rendering instructions in the form of a character string and color parameters are prepared based on the received data and the received chart parameters, as shown in block 216. The color parameters may be a numerical reference to a color. The graphics engine may prepare character strings in a proprietary TrueType or other font to render the specified chart or other graphic representation of the data. The graphics engine may prepare rendering instructions in the following format:
(from_string_pos[1]-to_pos_string_pos[1], apply_color [1];
from_string_pos[2]-to_pos_string_pos[2], apply_color [2];
from_string_pos[N]-to_pos_string_pos[N], apply_color [N]).
   The rendering instructions may alternate between a character string used to render a portion of a graph or chart and a color for the particular portion of the graph or chart. The color specification is optional such that color may be included with some but not all of the characters.

A chart, graph or other graphics based on the graphics rendering instructions may be rendered in an application program or other software program, widget, plug-in or applet using a proprietary font, as shown in block 218. The proprietary font may be a TrueType font, and the graphic rendering instructions may include color formatting instructions. As will be discussed in more detail below, these steps may be performed on a single computing device, and may be shared between one or more clients and one or more servers.

Depending on the front end used, a graphical user interface may be included via an application program plug-in to make it easier for a user to specify data locations, chart parameters, and other information used in rendering graphics. Another embodiment of the basic process of rendering graphics is described in flow chart 222 of FIG. 2.

According to the method shown in flow chart 222, as a first step, data is received, as shown in block 232. In one embodiment, the data is received from a computer user in an application program such as Microsoft Excel, other spreadsheet program, Microsoft Word or other word processing program, Microsoft PowerPoint or other presentation software, or other application software. In other embodiments, the data is received from a third party or a device over a network by an application program, desktop widget, applet or other software. Data received over a network may include test scores, sales figures, weather data, stock prices and many other kinds of data which may be provided by a third party, an affiliated organization, or other entity.

In one embodiment, the data is received by a computing device such as a personal computer 120. The following actions may also be performed on other computing devices. A selection of a kind of chart is received, as shown in block 234. This may be achieved by a user selecting a kind of chart from a pull-down menu, dialog box or other graphical user interface technique. The kinds of charts supported may by one or more of a variety of graphics used to display data in a readily understandable manner, including, pie chars, bar charts, line graphs, bullet graphs, and variants of these such as win-lose charts, area graphs, and others. A user selection of a formula may then be received, as shown in block 236. The formula may be one of a variety of system pre-defined formulas and/or may be user settable or user editable. The formula is then processed in view of the received data to create graphics rendering instructions to be used to create an inline chart, as shown in block 238. This is discussed in greater detail below. An inline chart is then rendered using the graphics rendering instructions using a proprietary font, as shown in block 240. In one embodiment, the font is a proprietary TrueType font. All of the steps may be performed by a single plug-in or extension to an application program such as Microsoft Excel in conjunction with the installation of one or more proprietary fonts. In this way, a user can specify data and how that data is to be displayed in a readily cognizable manner as an inline chart or graph. As used herein the phrase “inline chart or graph” refers to charts and graphs that are rendered in a document, file or window such that the graphs and charts have a height approximately equal to the height of neighboring text and/or data.

In another embodiment, the data may be received by a server 110 from a third party and communicated to a client device such as computing devices 120, 130, 132, 134 and 136. In this embodiment, the client device may process the data and display it to the user of the client device, as set forth in blocks 234, 236, 238 and 240 as described above. In this embodiment, the client device may have a plug-in and/or graphics engine running in conjunction with an application program such as, for example, Microsoft Excel or PowerPoint. Also, in a related embodiment, the client device may have a widget or other applet or desktop enhancing software that includes or communicates with a graphics engine that executes on the client device to perform the actions set forth in blocks 232, 234, 246 and 238 as described above. Depending on the particular embodiment, the system may receive from a user a specification or selection of the data to be received, or the data may be part of a subscription, such as, for example, sports data or stock prices to which a user subscribes via the third party. Similarly, depending on the embodiment, the selection of a type of chart may be received from a user or from a third party server based on preferences the third party received from the user.

In yet another embodiment, the data may be received 232 by a server 110 from a third party and then processed as set forth in blocks 234, 236, and 238 as described above. In this embodiment, the server then communicates graphics rendering instructions to a client device such as computing devices 120, 130, 132, 134 and 136 such that the computing device displays the data as processed and formatted by the server 110. In this embodiment, the client device may only need to have installed the proprietary TrueType font or other proprietary font in an application program, widget or other applet or desktop enhancement software to display the graphics based on graphics rendering instructions received from the server, as shown in block 240.

Methods of Rendering Inline Graphics

True type fonts are vector fonts. The character size of TrueType fonts is adjustable without a loss in quality. True type fonts are comprised of a plurality of glyphs. A glyph defines the visual representation of a graphical element on a display or a printer. TrueType fonts describe each glyph as a set of paths. A path is a closed curve specified using points and mathematics. A lower case ‘i’ has two paths, one for the dot and one for the stem. The paths are filled with pixels to create the final letter form. The set of paths is called an outline. Using the outline, characters are rendered on a display or printer. According to the TrueType font specification, each glyph is limited to a single color. The current specification of TrueType fonts does not allow multi-colored glyphs. Glyphs are rendered or drawn on a display by activating pixels or dots on the display according to any of various well known techniques.

A glyph also specifies an advance width. After is glyph is rendered, the next glyph is rendered at a horizontal position following the current glyph as defined by the advance width. Because glyphs are positioned relative to a given point on the screen or page, TrueType fonts specify the horizontal distance the current point moves after a glyph is drawn. This horizontal distance is the advance width. An overstriking glyph—a glyph that is rendered on top of another glyph—has an advance width of zero. A space glyph has a large advance width, as there is no actual glyph outline for a space, and the space is created by specifying a large advance width for a current character.

Charts and other graphics can be produced as a sequence of characters of a font such as a TrueType font. In a rudimentary way, this may be done using the box drawing and block elements codes included in the Arial Unicode MS font available from Microsoft Corporation of Redmond, Wash. However, using this font only provides very basic graphs and charts.

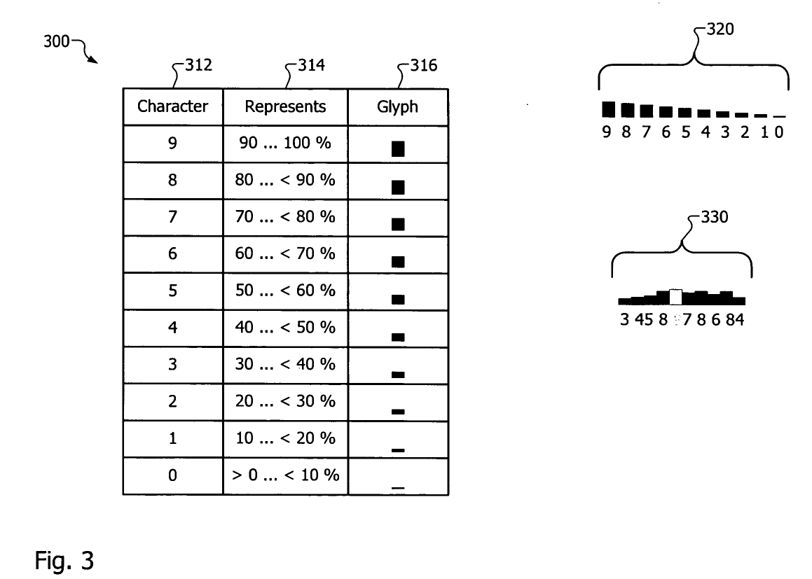

Referring now to FIG. 3, a table 300 and illustrations 320 representing a method of rendering graphics is shown. In this embodiment, input data is normalized so that the smallest value is 0 and the largest value is 1. A resolution of n for charts to be rendered is defined. In the example shown, n=10. The normalized values are divided into intervals of the length 1/n i₁=(0, 1/n), (1/n, 2/n), . . . , iₙ=((n−1)/n, 1/n). Each interval 314 is mapped to an index 312 based on the normalized value. The representative font character 312 is calculated from the interval index. A set of associated glyphs 316 corresponds to the particular index 312. Each value of the input data represents one character, the glyph 316, the graphical representation of one character 312. The relationship between the sizes of the glyphs 316 may be seen in illustration 320 which shows the glyphs resulting from specifying characters 9 through 0.

Inline charts with data bars of varying color can be produced as a sequence of characters like those shown in FIG. 3, where some characters have a different color. Referring now to illustration 330 of FIG. 3, each value of the input data is represented by one character, the glyph 316, and the graphical representation of the particular character has the same color of the character. This is made evident by the colored 9 and corresponding glyph in illustration 330.

However, charts and other graphics with overlaid chart components such as reference lines of varying color can not be created with the method mentioned above. This is because one value of the input data set represents one character only, and one character is represented by one glyph. Each glyph has an advance width to move the current point in the x-direction, that is horizontally. Since a glyph only can have one color according to the TrueType font specification, it is not possible to overlay other chart components, like a reference line, onto a graph made using the technique described regarding FIG. 3.

According to one novel method, inline charts that readily show the meaning of data may be rendered in an application program or other software using a proprietary font. A benefit of these charts is that they can include reference lines, colored lines, colored data points that are distinguished from a graph line color, different colors for positive and negative values in a column, and more. The charts may also update automatically when input data changes. In one embodiment, the method may be implemented within an application program using proprietary TrueType fonts to render a graphical representations according to user specified parameters.

The methods described herein allow for plug-in provided, user-defined and third party program defined functions to calculate charts having multicolored features that can be included in application programs such as spreadsheets, word processors, and presentation programs, and in applets, plug-ins, widgets, and the like, including, for example, Microsoft Excel, Microsoft Word, Microsoft PowerPoint, and others. According to the methods described herein, charts with overlaid components of varying colors can be produced as a sequence of characters and color commands, instructions and the like.

One value of the input data is represented by sequences of glyphs where each glyph has one color associated with it. To achieve the novel multicolored features, the glyphs are defined in a proprietary font to have no advance width. This allows overstriking or overlaying of glyphs. Each glyph sequence may end with a space glyph which, in one embodiment, is mapped to the character “+”. The space glyph or advance character may be another character from the ASCII or other character set.

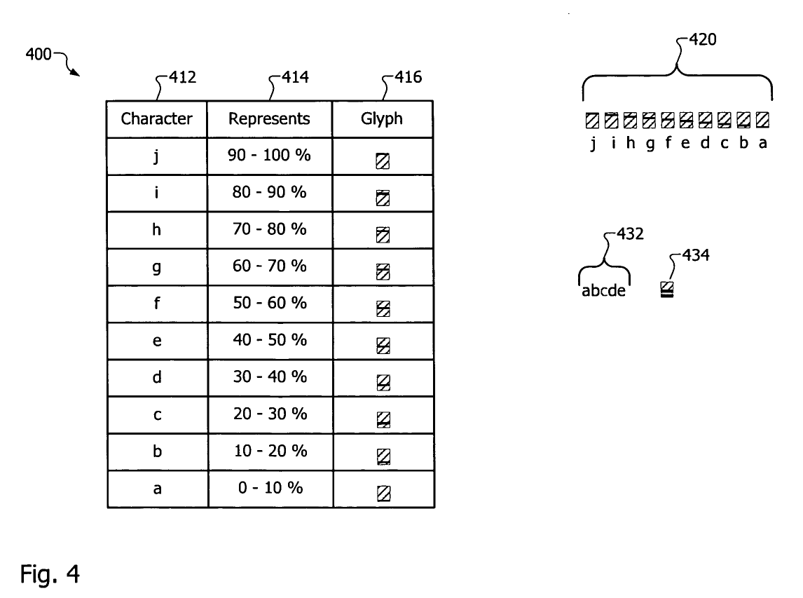

A glyph sequence contains glyphs where each glyph of the proprietary font represents a segment of the graph component referred to as a segment glyph. In various implementations, the glyph segment may be part of a pie segment, the rectangular part of a bar or column chart, a line segment of a line chart, etc. The whole chart may be divided into 1/n segment glyphs, where n is the gradation of the chart components. For example, FIG. 4 shows a rectangular bar chart component having a resolution of 1/10 such that 10 segments glyphs represent 100%. FIG. 4, shows the segment glyphs in black with the entire maximum size glyph cross hatched for explanatory reference purposes only.

A sequence of characters like “abcde” shown as element 432 of FIG. 4 produces a bar of 50% height shown as element 434. If a reference line is requested to show an average value at a particular time, the letter “c” representing 20-30% or the average value may be assigned the color of the reference line. As shown in elements 432 and 434, this color is red. The rectangular bar 434 would be produced by rendering each of a, b, c, d and e before advancing to the next glyph. That is, the glyphs of each of a, b, c, d, and e of element 432 would be rendered by overstriking, and the glyph for the letter c would be rendered in the color red. Since each character constitutes a glyph, each character can have a color. The resulting bar can have segment glyphs with multiple colors, building as a result a multicolor glyph. This is what allows for overlying chart elements like a reference line.

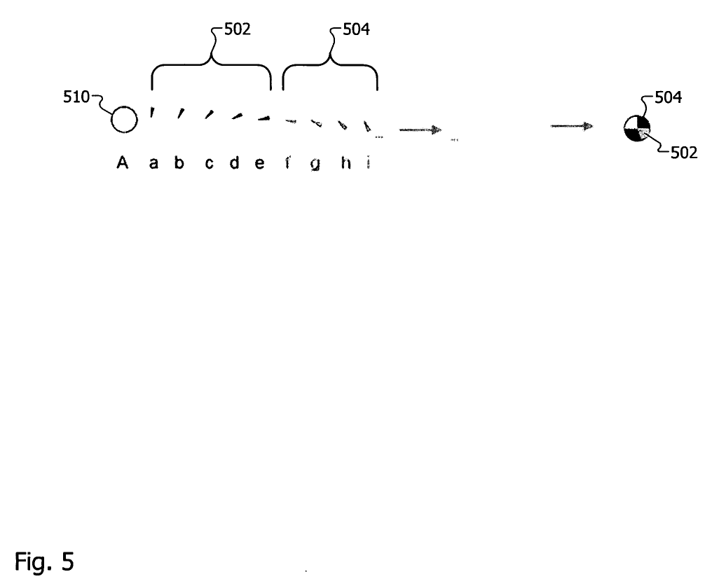

The same principle works for pie charts where a sequence of characters encodes the pie segments, as shown in FIG. 5. For example, the characters “abcde” are used to create portion 502 in black and the characters “fghi” are used to create grey (or colored) portion 504 of the pie chart shown in FIG. 5. In one embodiment an entire circle may be broken down into 360/n segments. Additionally, certain characters may be given special properties based on the particular chart. For example, an outline or border circle 510 may be defined as capital A.

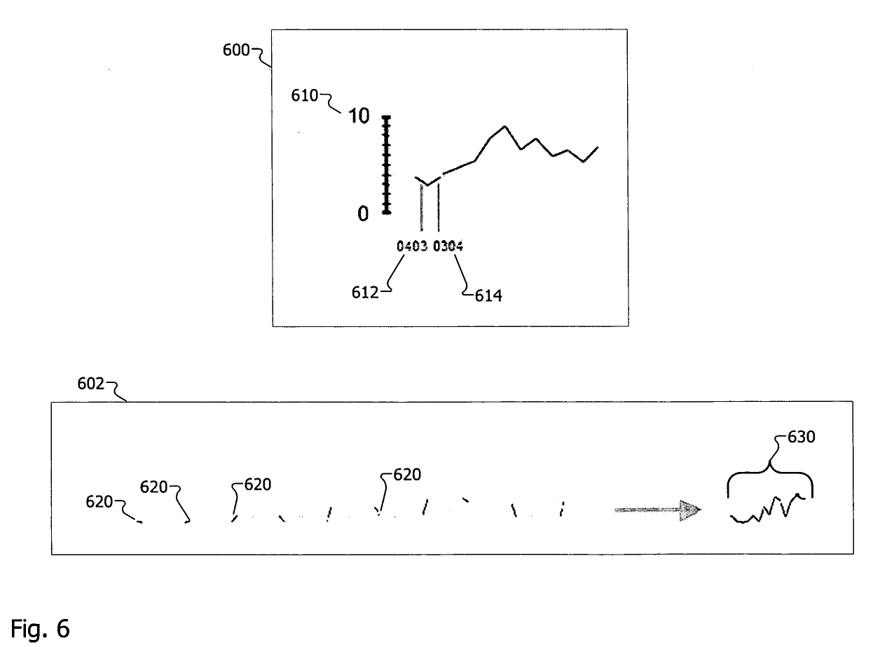

FIG. 6 is an illustration of a method of rendering a line graph. As described above with other kinds of graphics, line charts may also be divided into n segments 610 as shown in example 600. In one embodiment, two data values define a line segment. A line segment connects the first data value with the second data value. If n=10, there are 10*10=100 line segments. Characters are encoded with codes, namely the computer representation of a character. For example, the ASCII code of the character “A” is 65. A line segment may be encoded with the following formula: code=index1*100+index2, where index is the index of the interval in which the value resides. According to this embodiment, the line segment that connects the 40% value with the 30% value is encoded as “0403”, shown as element 612. Similarly, a line segment that connect the 30% value with the 40% value is encoded as “0304”, shown as element 614. Other techniques may also be used.

Illustration 602 shows the constituent components 620 of line chart 630. Each portion of the line of the line chart is rendered using a line portion glyph 620. The selection of the line portion glyph is based on mathematical analysis of the retrieved or provided data. Each of the line portion glyphs 620 is rendered using a character from a proprietary font comprising multiple line portion glyphs 620 having various characteristics, such as conforming to particular angles and shapes.

In some implementations, the method can produce very long character sequences to render the chart or other graphics. Because some application programs support a limited amount of characters, reducing the amount of characters is useful. For example, Microsoft Excel cells are limited to 1,024 characters. The number of characters can be reduced by using larger glyphs, or glyphs having additional shading in place of multiple glyphs having smaller segments. A reduction in the character string length may be achieved by substituting segment glyphs with glyphs that span multiple segment glyphs. When n=10, five segment glyphs (namely the string “abcdef”) are needed to span a 50% column bar. To reduce the number of characters needed, the letters K and L may be defined to produce glyphs that span the 0%-50% column bars and the 50%-100% column bars. In this example, the character K may represent a 0%-40% column bar that can be used in place of “abcde”. As such, the end result is “Kf”, rather than “abcdef”. This method can be implemented for various intervals, such as, for example, 25% increments, 12.5% increments, and so on. This technique results in significantly shorter characters sequences.

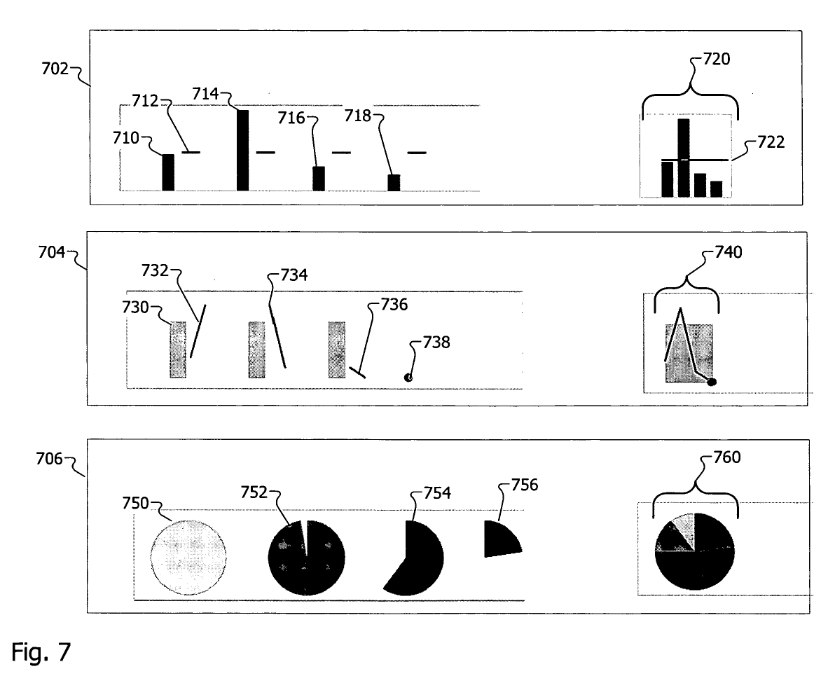

FIG. 7 is a series of three illustrations showing how graphs are rendered according to an improved method of rendering graphics. Illustration 702 shows the constituent glyphs 710, 712, 714, 716 and 718 used to render the column graph 720 having a reference line 722. Using the terminology above, rather than having a series of five characters “abcde” to represent a column of 50% height, a single letter may be used to render a column of 50% height as shown by element 710. To overlay a normal band 722 or other reference line, the character sequences representing glyphs of line segments 712 may be combined with and overlaid on the character sequences representing glyphs of column bars 710, 714, 716 and 718. The reference line, normal band, mean bar or average line 722 may be built using character sequences representing glyphs of line segments or column segments. This technique of rendering reference and other lines may be implemented with a variety of kinds of charts and graphics; that is, this technique is not limited to column bar graphs.

The steps taken in illustration 702 include the rendering of a column glyph having a particular height and no advance width followed by a horizontal line of the same width as the column shown as 712, followed by a full column width advance. This is repeated until the graph 720 having reference line 722 is produced. In one embodiment, the graph 720 is rendered using a proprietary TrueType font and a character string.

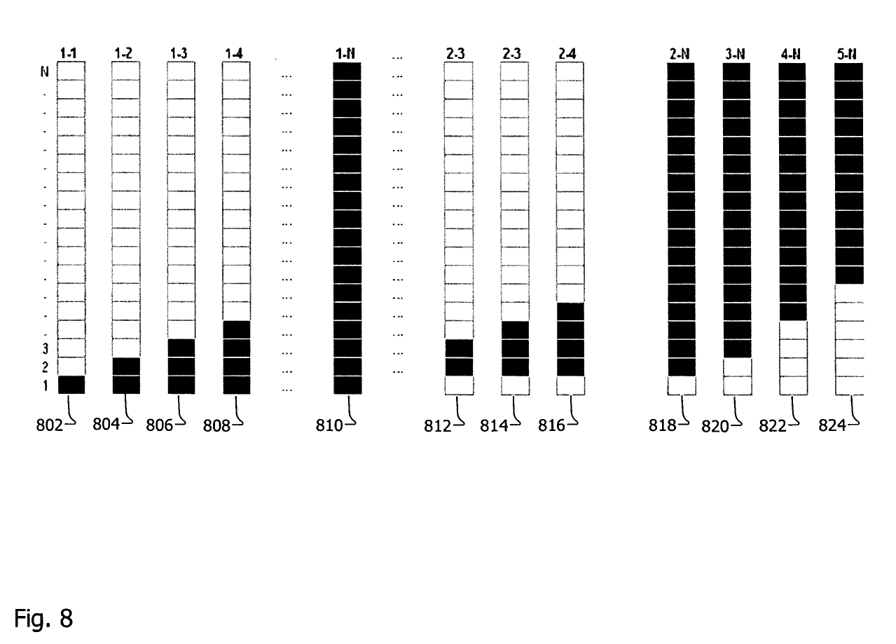

Referring now to FIG. 8, there is shown some example glyphs included in a font used to render bar charts. Each of the glyphs 802-824 may be rendering using a single corresponding character. Just as rendering a capital “F” in “RockWellExtraBold” as

[symbol]

may be achieved by specifying a font name, in its simplest form, to render a single vertical bar like glyph 810, the letter “F” could be used with the name of a particular proprietary font. In one implementation, if the font “BarCharFont” is selected, the letter “F” would produce the glyph 810. This font name is only an example, and any descriptive or publicized name can be used. In its most basic sense, conceptually, this works in a way similar to the way the popular webdings and wingdings fonts work, a difference being that the proprietary fonts used to implement the graphics rendering techniques described herein have no advance width. This allows for overstriking which allows for multiple colors in a single column as well as the use of reference and other lines.

As to construction of the proprietary fonts, the column width or horizontal width of the font may be system defined as shown in FIG. 8. The segmentation of the vertical height may be in N pieces as shown in FIG. 8. The proprietary font for vertical or bar graphs may include each of the single segments shown in FIG. 4, and may include large vertical segments that vary from height of one to a maximum height of N segments. A columnar glyph may be defined by a pair of numbers representing a starting location and an ending location on a vertical scale going from bottom to top. As shown by element 806, segment glyph 1-3 begins at the bottom segment and goes up to the third segment. Similarly, as shown by element 812, segment glyph 2-3 begins at the second segment from the bottom and goes up to the third segment. Likewise, as shown by element 822, segment glyph 4-N begins at the fourth segment from the bottom and goes up to the Nth segment, the top or highest segment. Other scales and arrangement schemes may be used to achieve the same goals.

Referring again to FIG. 7, illustration 704 shows the constituent glyphs used to render the line graph 740. To create this line graph, a series of grey columns 730 alternating with line glyphs 732, 734, and 736 are followed by a column width advance are specified and rendered. But the last line glyph 736 is not followed by a column with advance, rather a bottom right red reference point 738 is rendered overstriking the line glyph 736 and the rightmost column glyph 732. In one embodiment, the graph 740 is rendered using a proprietary TrueType font and a character string.

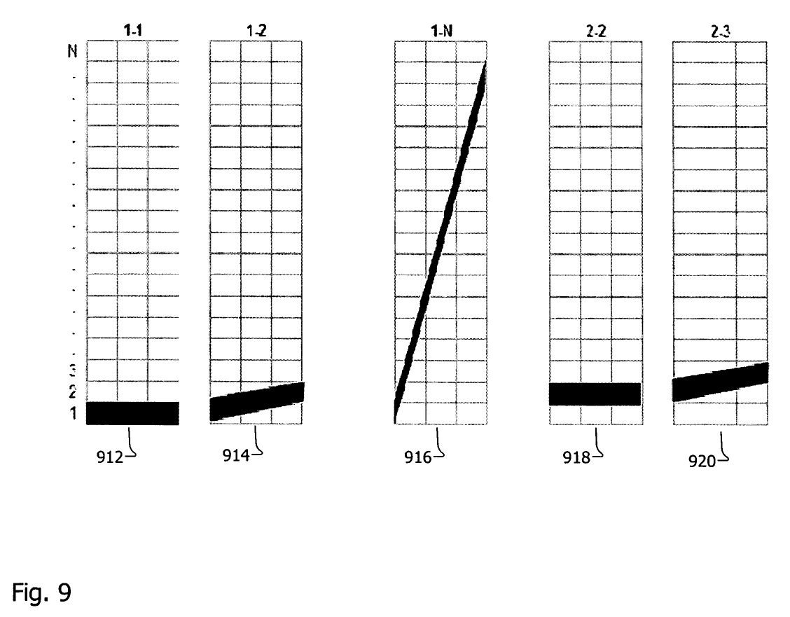

Referring now to FIG. 9, there is shown some example glyphs included in a font used to render line charts. In this version of the line chart font, each of the glyphs has a width of three and a height of N. As earlier described, each character in the font is used to render a portion of a line graph like the line graph shown in line graph 740 of FIG. 7. Each of the characters or glyphs in the proprietary font for line graph rendering shown in FIG. 9 may be defined by a pair of numbers representing a starting location and an ending location on a vertical and horizontal scale going from bottom to top and left to right. As shown by element 914, segment glyph 1-2 begins at the bottom-most segment and goes up to the second segment. Similarly, as shown by element 916, segment glyph 1-N begins at the bottom segment and goes up to the highest segment N. Likewise, as shown by element 920, segment glyph 2-3 begins at the second segment from the bottom and goes up to the third segment as the line goes from left to right. Other scales and arrangement schemes may be used to achieve the same goals.

Referring again to FIG. 7, illustration 706 shows the constituent glyphs used to render the pie chart 760. To create this pie chart, a series of pie piece glyphs 750, 752, 754 and 756 are specified and rendered. The glyphs are rendered by overstriking such that none of the pieces have an advance width associated with them. By using the larger pie pieces 750, 752, 754 and 756 the character string needed is shortened when compared to the method described above regarding FIG. 5. In one embodiment, the graph 760 is rendered using a proprietary TrueType font and a character string.

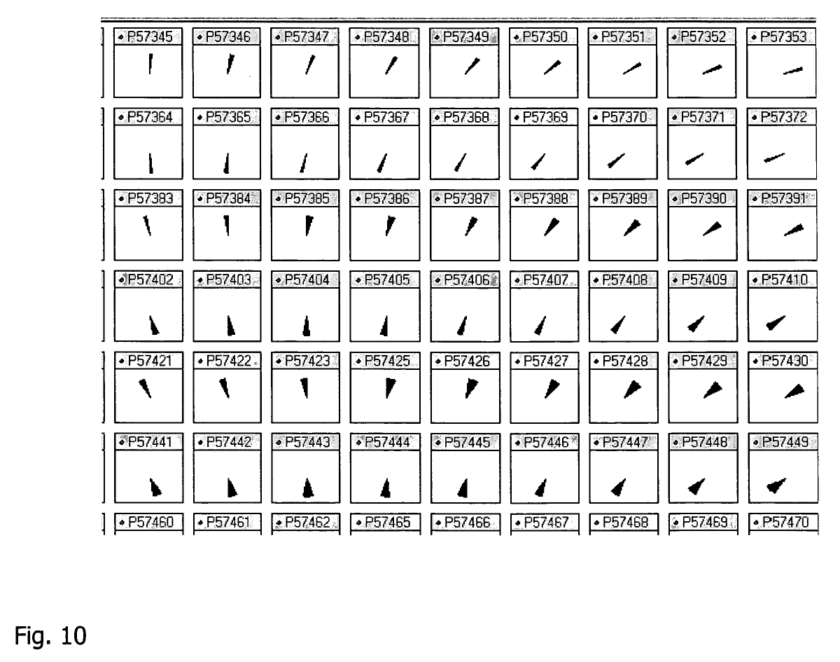

FIG. 10 is a block diagram of a detailed view of example glyphs of a font used to render pie charts. The glyphs shown in FIG. 10 are only a sampling of the pie slices that are made available by a part chart proprietary font. The pie slices available may be relatively small slices like those shown in FIG. 10 and relatively large like those shown as elements 754 and 756. Each of the glyphs 752, 754 and 756 may be rendered using the smaller glyphs shown in FIG. 10.

In another embodiment, the pie chart may be rendered by smaller pie slice glyphs from left to right such that all of the rightmost glyphs and their colors are rendered, followed by the middle piece slice glyphs and their colors, through the right-most. The number of columns from left to right may vary depending on the implementation.

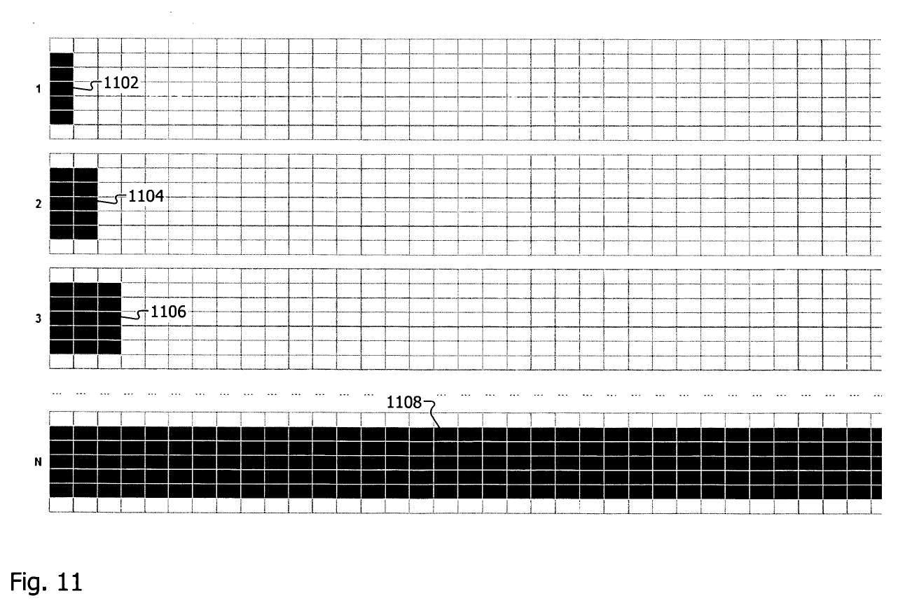

FIG. 11 is a block diagram of a detailed view of example glyphs of a font used to render horizontal bar charts and bullet graphs. The glyphs shown FIG. 11 may be a horizontal version of the vertical glyphs shown in FIG. 8. Although shown as starting from left in example 1102, 1104, and 1106, the horizontal bar font may include glyphs that start from the right, center, or other locations.

Example Implementation

In one embodiment, graphics rendering software in the form of a plug-in or application extension may be executed in conjunction with an application program such as Microsoft Excel and a proprietary TrueType font. The graphics rendering plug-in serves as a front end to a graphics rendering engine.

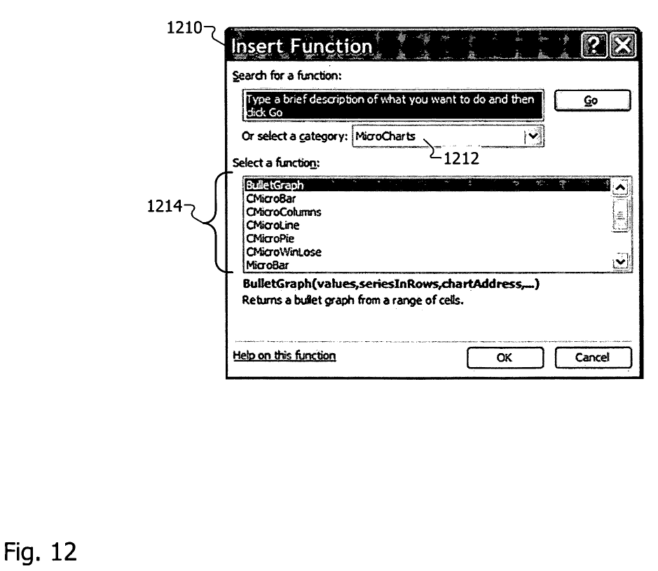

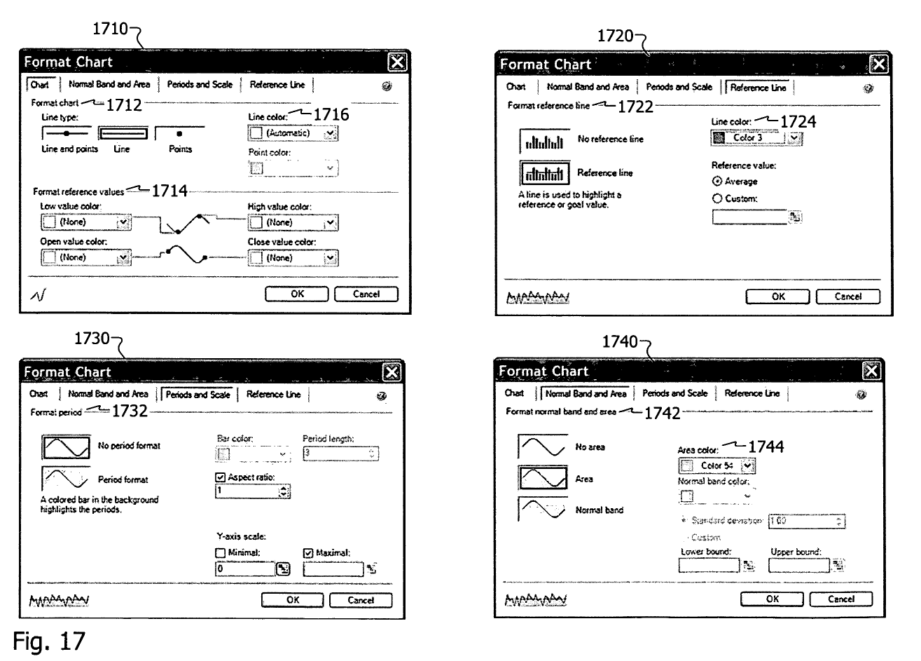

According to this embodiment, data is first entered into a spreadsheet. A plug-in to the spreadsheet program receives the user's selection of data and the user's specification of the kind of chart or graph desired. This is achieved according to the methods described and shown regarding FIGS. 12-16, below. After the chart is selected, changes to the formatting may be made using the dialog boxes shown in FIG. 17. Based on the user's selection of information in the various dialog boxes shown in FIGS. 12-17, the appropriate function and the appropriate parameters are stored in a cell in the spreadsheet. The function is, in one embodiment, a procedure or software written pursuant to Microsoft Excel's user defined function requirements that accesses a graphics engine. The function is activated or triggered by the spreadsheet program. Various functions may be provided by the graphics rendering plug-in to the spreadsheet. Example user defined functions included in one implementation of a spreadsheet plug-in are: BulletGraph, CMicroBar, CMicroColumns, CMicroLine, CMicroPie, CMicroWinLose, Microbar, MicroColumns, MicroLine, and MicroWinlose. Each of these functions are called with input parameters that may be publicized as an API for the plug-in and/or the graphics engine, and may be user accessible. An example list of parameters that define the input for a function is provided above in the discussion in paragraph [0040].

In Microsoft Excel, the functions provided by the plug-in are used to overcome a deficiency in Microsoft Excel. Excel formulas do not support color characters. In addition, Microsoft Excel does not allow for the rendering color graphs having reference, normal average or other lines and color points and colored areas together. To overcome this limitation of Microsoft Excel, multi-colored character sequences can be implemented indirectly with user defined functions. The graphics rendering plug-in prepares a formula, the function, having as input parameters a reference to the input data and a reference to a result. When Microsoft Excel calculates the function, the resulting character strings are stored in a list or cache by the function. When the function is recalculated by Microsoft Excel (during an OnRecalc Excel Event), the function processes the list of all formulas and the multi-color character strings. This is successful because the Microsoft Excel API supports setting multi-colored character strings even though Excel formulas do not support multi-colored character strings.

The same kind of plug-in may be included in other application programs, including, for example, word processors such as Microsoft Word, presentation programs such as Microsoft PowerPoint, and others. In addition, widgets and desktop enhancers could also access the methods described herein by making API calls to the graphics engine.

In the spreadsheet embodiment, the dialog boxes shown in FIGS. 12-17 are provided so that a user may select features and attributes, specify data and function location, and provide other parameters which are used with the function to create the inline graph.

FIG. 12 is an example insert function dialog box 1210 used to insert a graphic according to a method of rendering graphics. The function dialog box 1210 may be reached by accessing a pull-down menu, selecting a button, selection a Microsoft Excel function, and/or other user interface technique. The insert function dialog box allows a user to select that an inline chart or graphic is desired as shown by element 1212. The insert function dialog box allows a user to select which kind of chart or graphics 1214 are desired. Some choices include color or non-color bullet graphs, line graphs, bar graphs, column graphs, pie charts, and others.

If a user already has data available or in a spreadsheet, the user may right clock in an open cell, access a pull-down menu, selecting a button, and/or access another user interface technique to select that the user wishes to create a chart or other graphic. In this scenario, a chart type dialog box may be provided.

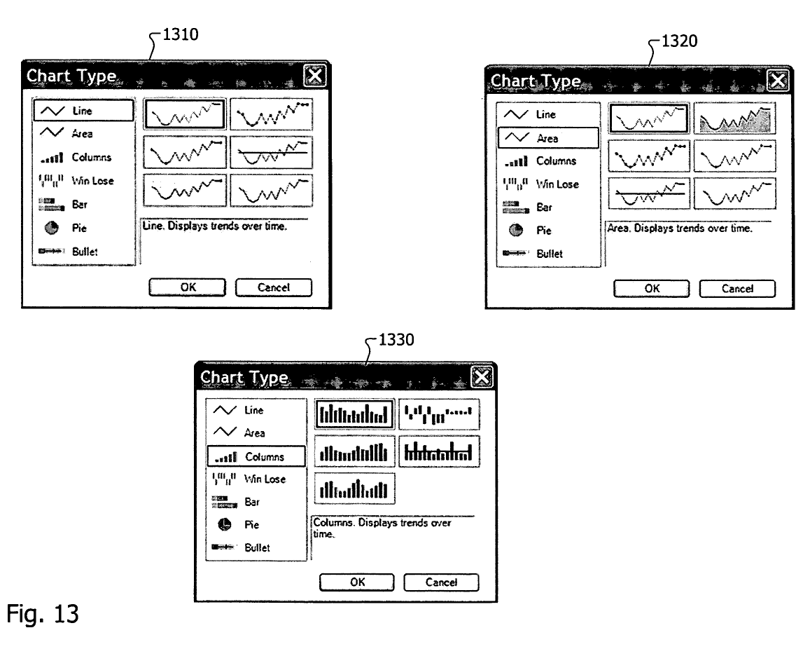

FIG. 13 illustrates three example chart selection dialog boxes. Chart type dialog box 1310 allows a user to select from six kinds of line graphs having various color enhanced features. Chart type dialog box 1320 allows a user to select from six kinds of area graphs, a line graph with the area below shaded, having various color enhanced features. Chart type dialog box 1330 allows a user to select from five variations of column or (vertical) bar graphs having various color enhanced features.

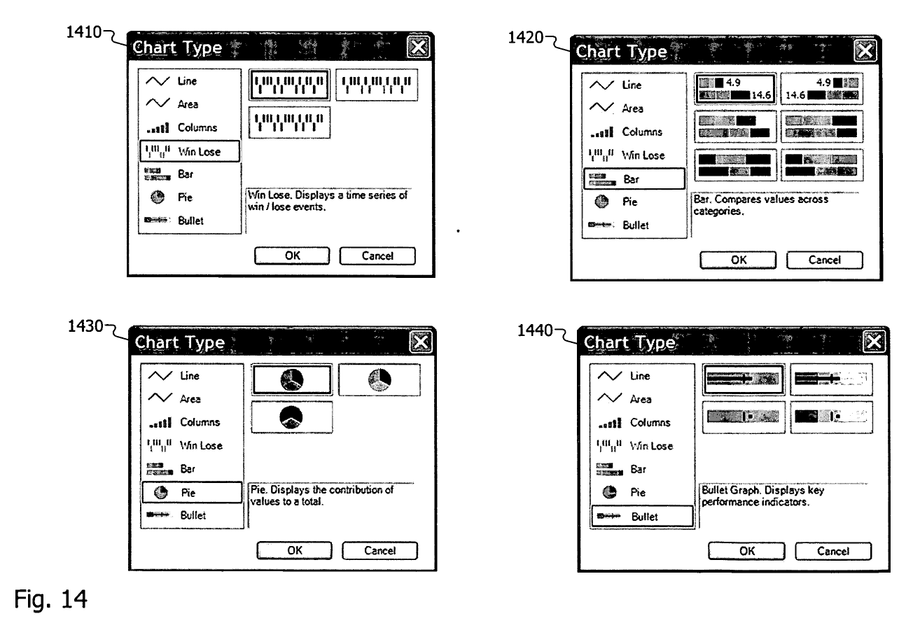

FIG. 14 illustrates four example chart selection dialog boxes. Chart type dialog box 1410 allows a user to select from three variations of win-lose graphs having various color enhanced features. Chart type dialog box 1420 allows a user to select from six variations of (horizontal) bar graphs having various color enhanced features. Chart type dialog box 1430 allows a user to select from three variations of pie charts having various color enhanced features. Chart type dialog box 1440 allows a user to select from four variations of bullet graphs having various color enhanced features.

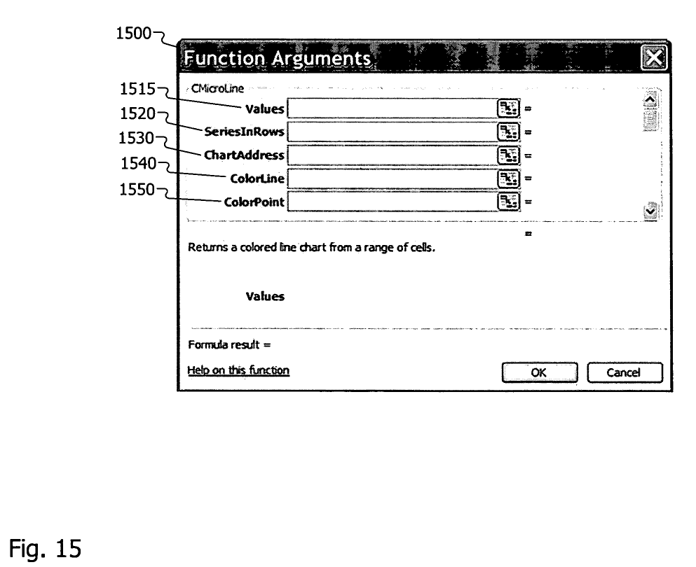

After the kind of chart or graphic is selected, the user may be provided a function arguments dialog box 1500 like that shown in FIG. 15. The function arguments dialog box 1500 allows a user to specify the value or location of the source data 1150, the series in the rows 1520, the address in the Excel spreadsheet where the chart or graphic should be rendered 1530, the color of the line or other component of the chart or graphic 1540, and whether one or more color points should be rendered and the color of the color points 1550. The contents of the function arguments dialog box 1500 may vary depending on the kind of chart or graphic selected. These fields may accept user typed entry and/or may allow a user to select cells from an Excel spreadsheet to provide the needed information.

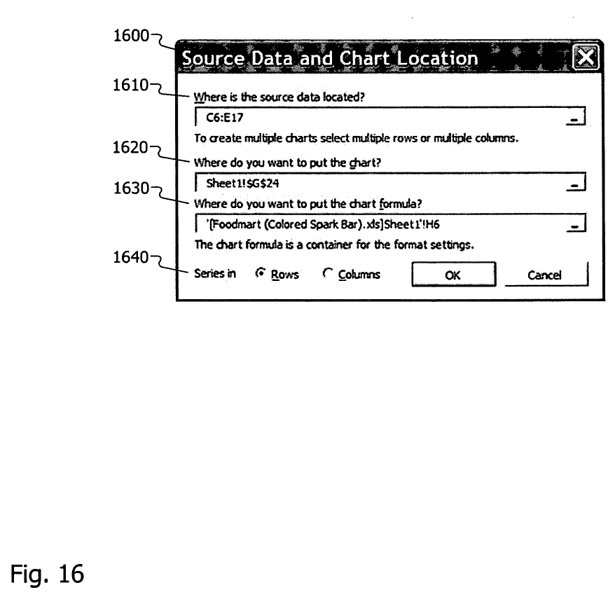

FIG. 16 is an example source data and chart location dialog box 1600. When a user elects to specify the value or location of the source data 1510 shown in FIG. 15, the source data and chart location dialog box 1600 may be provided. The source data and chart location dialog box 1600 allow a user to specify where the source data is located 1610, where the chart or other graphic should be rendered 1620, where the formula used to render the chart or graphic should be located 1630, and whether the series is located in rows or columns 1640.

FIG. 17 illustrates four example chart format dialog boxes according to an embodiment of a method of rendering graphics. After a chart or other graphic has been created, the format chart dialog box allows a user to customize or edit various features of the particular chart or graphic. For example, format chart dialog box 1710 provides a user the ability to edit the format of the chart 1712, namely whether a line graph is lines and points, line, or points, and whether reference values should be included and their format 1714 and color 1716. Format chart dialog box 1720 provides a user the ability to add and format a reference line of the chart 1722, including selecting the color of the reference line 1724. Format chart dialog box 1730 provides a user the ability to add and format a period for the chart 1732. And format chart dialog box 1740 provides a user the ability to add and format a normal band and/or area 1742 including the color 1744 of the area.

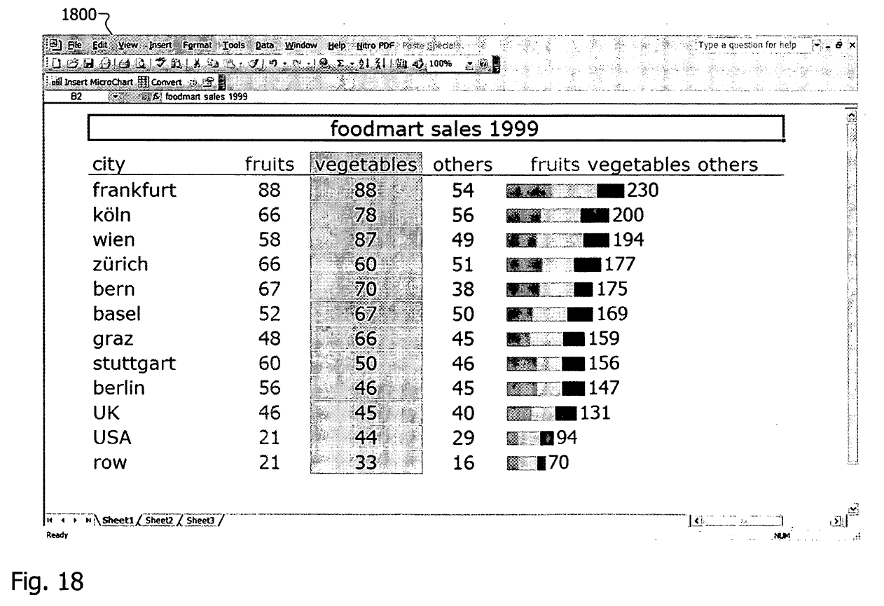

The following examples show how adding inline charts and graphs to spreadsheets makes the information hidden in the raw data readily apparent. These examples were created according to the methods described above. FIG. 18 is a screen shot 1800 of an example spread sheet including color bar graphs reflecting the data in the spread sheet. The function used to create one of the inline bar graphs shown in the spreadsheet in this example is
=CMicroBar(C6:E 17,1,F6,0,15,42,14,34,16764157,12632356,9869050,84 21604,3355543,1,−1, “0”, “Tahoma”,20,0)

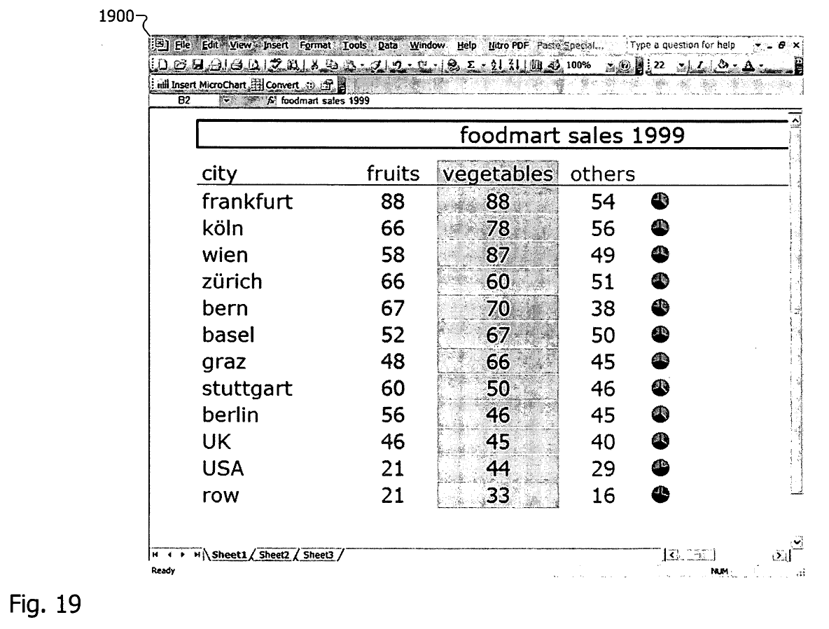

FIG. 19 is a screen shot 1900 of an example spread sheet including color pie charts based on the same data used in FIG. 18. The function used to create one of the inline pie charts shown in the spreadsheet in this example is:
=CMicroPie(C6:E17,1,F6,3,16711780,10,16764157,12632356,9869050,8 421604,3355543)

The impact of the data presented in a table of headers and numbers is dramatically increased by using the color enhanced inline graphs in the spreadsheets shown in FIGS. 18 and 19.

One particular characteristic of TrueType based inline graphs and charts is that they behave and format like typical text. The graphic or chart rendered may be aligned left, right, and center as with other fonts. In this way, as text and data are formatted, the same formatting properties may be concurrently applied to inline graphs rendered according the methods described herein. This is particularly useful when the column width or row height in a spreadsheet, word processing file or presentation is changed because it allows the rendered inline graphs to adapt automatically along with the associated test and/or data in the file. Specifically, When a cell or other area in a file is formatted, the inline chart can have formatting properties applied to it as if it were a typical text font. The formatting properties that may be applied include, for example, alignment, orientation, width, height, font size, conditional formatting, and automatic alignment with row height changes.

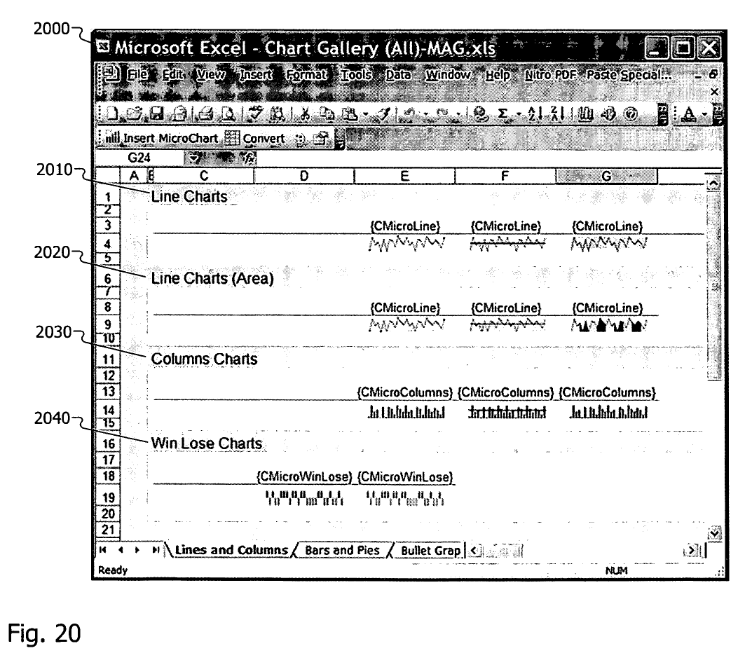

FIG. 20 is a screen shot of a portion of an example spread sheet including various charts and graphs created using the methods of rendering charts and graphics described above. All of the line charts 2010, area charts 2020, and column (vertical bar) charts 2030 reflect the same data in different ways. The three line charts 2010 all reflect the same data and show the benefits of having different chart features selected. The different features include colored data points, and a reference line. The three area charts 2020 all reflect the same data and show the benefits of having different features selected. The three column (vertical bar) charts 2030 all reflect the same data and show the benefits of having different features selected. The two win-lose charts 2040 reflect the same data and show the benefits of having different features selected, namely color and shading. The supporting data for the graphs shown in FIG. 20 are provided in FIG. 21, where similar numbers in the tens location show the correspondence between the two drawings. That is, the data shown in table 2110 was used to render and is displayed as the graphs shown by element number 2010.

The purpose of the methods described herein can be seen by review of FIGS. 20 and 21. If a salesman, business person, student, or teacher was making a presentation and put the raw data tables shown in FIG. 21 on a screen, trends and other derivative information would be difficult to discern. Representing the same data as inline graphs and charts using the methods described herein is an easy way to more clearly communicate information contained in the data shown in FIG. 20.

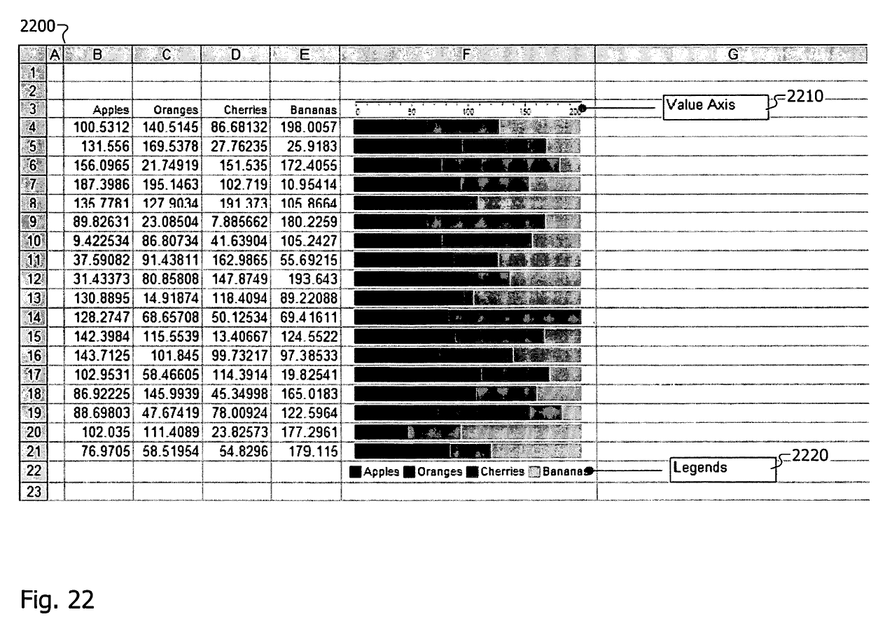

In addition, the display of data as graphs can be enhanced with the addition of an axis, legends FIG. 22 is a screen shot of a portion of an example spread sheet 2200 including graphs having an axis 2210 and a legend 2220 rendered according to a method described herein. The axis 2210 shown is an example of a value axis that may be derived by functions from the data provided in the spreadsheet. An axis may also have categories rather than values. The rendering of the lines of the axis is done similar to the chart rendering of the horizontal bar chart, that is by drawing glyphs having appropriate advance widths. The alphanumeric characters used to label the axis are alphanumeric glyphs that have no advance width.

Closing Comments

The description herein addresses graphics rendering from left to right used with fonts that are rendered from left to right. The same techniques as described herein may also be applied for fonts rendered from right to left and from top to bottom with alterations known to those skilled in the art. As such, the methods described herein are equally applicable to render color and complex inline graphics for top to bottom and right to left languages and their fonts.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, that is to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “chart” and “graph” are used synonymously herein.

As used herein, “and/or” means that the listed items are alternatives, but the alternatives also include any combination of the listed items.

It is claimed:

1. A method for rendering graphics using a font, the method comprising:
receiving data
receiving graph parameters
preparing graphics rendering instructions based on the received data, the received graph parameters, and at least one proprietary font, wherein the graphics rendering instructions comprise a character string and color parameters.

2. The method of claim 1 further comprising:
rendering a graph based on the graphics rendering instructions by accessing a proprietary font

3. The method of claim 2 wherein the rendering causes the graph to be displayed in one of an application program, widget, plug-in or applet.

4. The method of claim 2 wherein the rendering includes drawing a line through the graph.

5. The method of claim 2 wherein at least one column portion of the graph are drawn with two or more colors.

6. The method of claim 1 further comprising:
forwarding the graphics rendering instructions to a client device.

7. The method of claim 1 wherein the proprietary font is a TrueType font.

8. The method of claim 1 wherein the proprietary font includes glyphs comprising constituent parts of at least one of a line graph, a horizontal bar chart, a vertical bar chart, a bullet chart, and a win-lose chart.

9. The method of claim 1 wherein the data is received from one of a spreadsheet and a server.

10. The method of claim 1 wherein the graph parameters are received from one of a computer program and a user.

11. A client device comprising a user input device, a display device, a processor, a memory, and a storage medium, the storage medium having instructions stored thereon which when executed by a the processor cause the client device to perform operations comprising:
receiving graphics rendering instructions from a server
rendering a graph on the display device based on the graphics rendering instructions by accessing a proprietary font
wherein the rendering includes at lest one of
drawing a line through the graph
drawing at least one column portions of the graph with two or more colors.

12. A storage medium having instructions stored thereon which when executed by a processor cause the processor to perform actions comprising:
receiving data
receiving graph parameters preparing graphics rendering instructions based on the received data, the received graph parameters, and at least one proprietary font, wherein the graphics rendering instructions comprise a character string and color parameters.

13. The storage medium of claim 12 having further instructions stored thereon which when executed cause the processor to perform further actions comprising:
rendering a graph based on the graphics rendering instructions by accessing a proprietary font

14. The storage medium of claim 13 wherein the rendering causes the graph to be displayed in one of an application program, widget, plug-in or applet.

15. The storage medium of claim 13 wherein the rendering includes drawing a line through the graph.

16. The storage medium of claim 13 wherein at least one column portion of the graph is rendered in two or more colors.

17. The storage medium of claim 12 having further instructions stored thereon which when executed cause the processor to perform further actions comprising:
forwarding the graphics rendering instructions to a client device.

18. The storage medium of claim 12 wherein the proprietary font is a TrueType font.

19. The storage medium of claim 12 wherein the proprietary font includes glyphs comprising constituent parts of at least one of a line graph, a horizontal bar chart, a vertical bar chart, a bullet chart, and a win-lose chart.

20. The storage medium of claim 12 wherein the data is received from a spreadsheet.

21. The storage medium of claim 12 wherein the data is received from one of a server and a user.

22. The storage medium of claim 12 wherein the graph parameters are received from one of a computer program and a user.

23. A computing device comprising a user input device, a display device, a processor, a memory, and a storage medium, the storage medium having instructions stored thereon which when executed by the processor cause the computing device to perform operations comprising:
receiving data
receiving graph parameters
preparing graphics rendering instructions based on the received data, the received graph parameters, and at least one proprietary font, wherein the graphics rendering instructions comprise a character string and color parameters
rendering a graph based on the graphics rendering instructions by accessing a proprietary font
wherein the rendering causes the graph to be displayed in one of an application program, widget, plug-in or applet
wherein the rendering includes at least one of
drawing a line through the graph.
drawing at least one column portion of the graph in two or more colors.

24. The computing device of claim 23 wherein the proprietary font is a TrueType font.

25. The computing device of claim 23 wherein the proprietary font includes glyphs comprising constituent parts of at least one of a line graph, a horizontal bar chart, a vertical bar chart, a bullet chart, and a win-lose chart.
